(19) United States
(12) Patent Application Publication
(10) Pub. No.: US 2026/0036769 A1
(43) Pub. Date: Feb. 5, 2026

(54) OPTICAL DEVICE AND METHOD OF MANUFACTURE

(71) Applicant: Taiwan Semiconductor Manufacturing Co., Ltd., Hsinchu (TW)

(72) Inventors: Zi-Jheng Liu, Taoyuan City (TW); Chiahung Liu, Hsinchu (TW); Ming-Fa Chen, Taichung City (TW)

(21) Appl. No.: 18/914,825

(22) Filed: Oct. 14, 2024

Related U.S. Application Data
(60) Provisional application No. 63/665,323, filed on Jun. 28, 2024.

(51) Int. Cl. G02B 6/42; G02B 6/36

(52) U.S. Cl. CPC G02B 6/4249; G02B 6/3692; G02B 6/4239; G02B 6/424; G02B 6/4244

(57) ABSTRACT

Optical devices and methods of manufacture are presented in which a fiber array unit is utilized to arrange optical fibers so that, once the fiber array unit is attached to an optical device such as a first optical package, the optical fibers are better aligned with edge couplers within the first optical package after the edge couplers have been warped out of a straight alignment.

### PRIORITY CLAIM AND CROSS-REFERENCE

This application claims the benefit of U.S. Provisional Application No. 63/665,323, filed on Jun. 28, 2024, which application is hereby incorporated herein by reference.

### BACKGROUND

Electrical signaling and processing is one technique for signal transmission and processing. Optical signaling and processing have been used in increasingly more applications in recent years, particularly due to the use of optical fiber-related applications for signal transmission.

Optical signaling and processing are typically combined with electrical signaling and processing to provide full-fledged applications. For example, optical fibers may be used for long-range signal transmission, and electrical signals may be used for short-range signal transmission as well as processing and controlling. Accordingly, devices integrating long-range optical components and short-range electrical components are formed for the conversion between optical signals and electrical signals, as well as the processing of optical signals and electrical signals. Packages thus may include both optical (photonic) dies including optical devices and electronic dies including electronic devices.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1-9 illustrate formation of a first optical package, in accordance with some embodiments.

FIGS. 10A-10E illustrate an attachment of a fiber array unit to the first optical package, in accordance with some embodiments.

FIGS. 11A-11B illustrate edge couplers and fiber array units on opposite sides of the first optical package, in accordance with some embodiments.

FIGS. 12A-12C illustrate edge couplers and fiber array units on adjacent sides of the first optical package, in accordance with some embodiments.

FIGS. 13A-13C illustrate edge couplers and fiber array units on adjacent sides of the first optical package with different lengths, in accordance with some embodiments.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Embodiments will now be discussed with respect to certain embodiments in which optical fibers within a fiber array unit are arranged offset with each other in order to help ensure a good alignment between the optical fibers and corresponding edge couplers located within a first optical package that have been warped out of place during a bonding process. The embodiments presented, however, are intended to be illustrative and are not intended to limit the ideas presented to the precise embodiments described. Rather, the ideas presented may be incorporated into a wide variety of embodiments, including all packages that use through substrate vias and cells, and all such embodiments may be included within the overall scope of the disclosure.

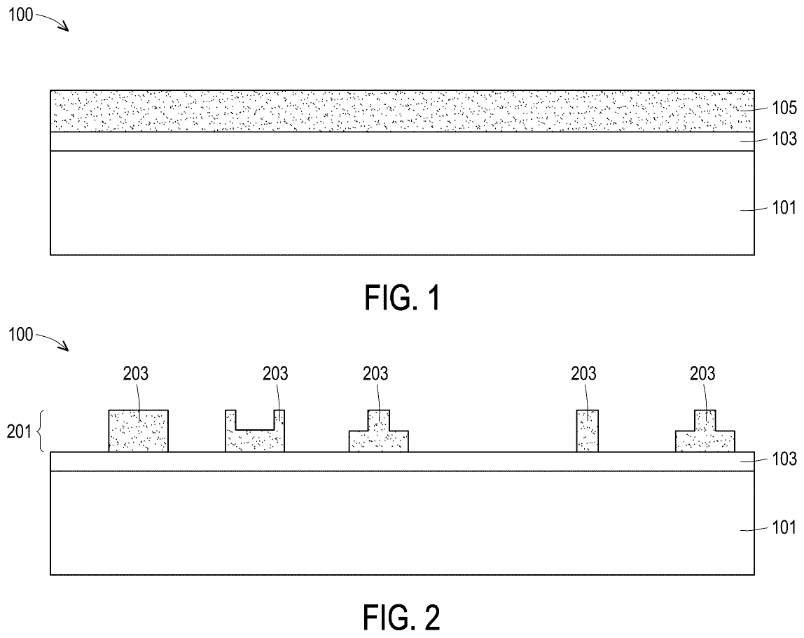

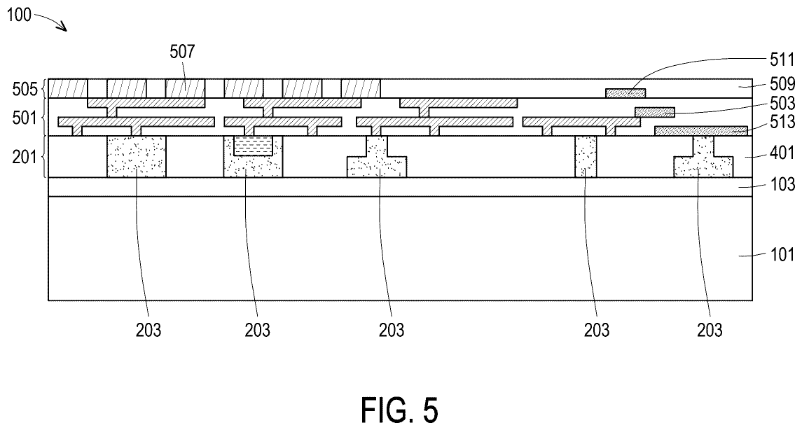

With reference now to FIG. 1, there is illustrated an initial structure of an optical interposer 100 (seen in FIG. 5), in accordance with some embodiments. In the particular embodiment illustrated in FIG. 1, the optical interposer 100 is a photonic integrated circuit (PIC) and comprises at this stage a first substrate 101, a first insulator layer 103, and a layer of material 105 for a first active layer 201 of first optical components 203 (not separately illustrated in FIG. 1 but illustrated and discussed further below with respect to FIG. 2). In an embodiment, at a beginning of the manufacturing process of the optical interposer 100, the first substrate 101, the first insulator layer 103, and the layer of material 105 for the first active layer 201 of first optical components 203 may collectively be part of a silicon-on-insulator (SOI) substrate. Looking first at the first substrate 101, the first substrate 101 may be a semiconductor material such as silicon or germanium, a dielectric material such as glass, or any other suitable material that allows for structural support of overlying devices.

The first insulator layer 103 may be a dielectric layer that separates the first substrate 101 from the overlying first active layer 201 and can additionally, in some embodiments, serve as a portion of cladding material that surrounds the subsequently manufactured first optical components 203 (discussed further below). In an embodiment the first insulator layer 103 may be silicon oxide, silicon nitride, germanium oxide, germanium nitride, combinations of these, or the like, formed using a method such as implantation (e.g., to form a buried oxide (BOX) layer) or else may be deposited onto the first substrate 101 using a deposition method such as chemical vapor deposition, atomic layer deposition, physical vapor deposition, combinations of these, or the like. However, any suitable material and method of manufacture may be used.

The material 105 for the first active layer 201 is initially (prior to patterning) a conformal layer of material that will be used to begin manufacturing the first active layer 201 of the first optical components 203. In an embodiment the material 105 for the first active layer 201 may be a translucent material that can be used as a core material for the desired first optical components 203, such as a semiconductor material such as silicon, germanium, silicon germanium, combinations of these, or the like, while in other embodiments the material 105 for the first active layer 201 may be a dielectric material such as silicon nitride or the like, although in other embodiments the material 105 for the first active layer 201 may be III-V materials, lithium niobate materials, or polymers. In embodiments in which the material 105 of the first active layer 201 is deposited, the material 105 for the first active layer 201 may be deposited using a method such as epitaxial growth, chemical vapor deposition, atomic layer deposition, physical vapor deposition, combinations of these, or the like. In other embodiments in which the first insulator layer 103 is formed using an implantation method, the material 105 of the first active layer 201 may initially be part of the first substrate 101 prior to the implantation process to form the first insulation layer 103. However, any suitable materials and methods of manufacture may be utilized to form the material 105 of the first active layer 201.

FIG. 2 illustrates that, once the material 105 for the first active layer 201 is ready, the first optical components 203 for the first active layer 201 are manufactured using the material 105 for the first active layer 201. In embodiments the first optical components 203 of the first active layer 201 may include such components as optical waveguides (e.g., ridge waveguides, rib waveguides, buried channel waveguides, diffused waveguides, etc.), couplers (e.g., grating couplers, edge couplers that are a narrowed waveguide with a width of between about 1 nm and about 200 nm, etc.), directional couplers, optical modulators (e.g., Mach-Zehnder silicon-photonic switches, microelectromechanical switches, micro-ring resonators, etc.), amplifiers, multiplexors, demultiplexors, optical-to-electrical converters (e.g., P-N junctions), electrical-to-optical converters, lasers, combinations of these, or the like. However, any suitable first optical components 203 may be used.

To begin forming the first active layer 201 of first optical components 203 from the initial material, the material 105 for the first active layer 201 may be patterned into the desired shapes for the first active layer 201 of first optical components 203. In an embodiment the material 105 for the first active layer 201 may be patterned using, e.g., one or more photolithographic masking and etching processes. However, any suitable method of patterning the material 105 for the first active layer 201 may be utilized. For some of the first optical components 203, such as waveguides or edge couplers, the patterning process may be all or at least most of the manufacturing that is used to form these first optical components 203 components.

FIG. 3 illustrates that, for those components that utilize further manufacturing processes, such as Mach-Zehnder silicon-photonic switches that utilize resistive heating elements, additional processing may be performed either before or after the patterning of the material for the first active layer 201. For example, implantation processes, additional deposition and patterning processes for different materials (e.g., resistive heating elements, III-V materials for converters), combinations of all of these processes, or the like, can be utilized to help further the manufacturing of the various desired first optical components 203. In a particular embodiment, and as specifically illustrated in FIG. 3, in some embodiments an epitaxial deposition of a semiconductor material 301 such as germanium (used, e.g., for electricity/optics signal modulation and transversion) may be performed on a patterned portion of the material 105 of the first active layer 201. In such an embodiment the semiconductor material 301 may be epitaxially grown in order to help manufacture, e.g., a photodiode for an optical-to-electrical converter. All such manufacturing processes and all suitable first optical components 203 may be manufactured, and all such combinations are fully intended to be included within the scope of the embodiments.

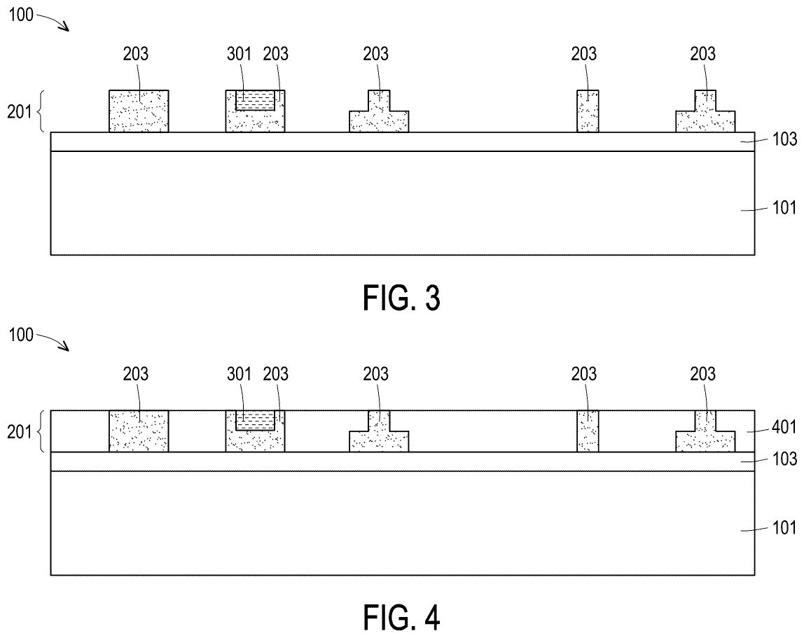

FIG. 4 illustrates that, once the individual first optical components 203 of the first active layer 201 have been formed, a second insulator layer 401 may be deposited to cover the first optical components 203 and provide additional cladding material. In an embodiment the second insulator layer 401 may be a dielectric layer that separates the individual components of the first active layer 201 from each other and from the overlying structures and can additionally serve as another portion of cladding material that surrounds the first optical components 203. In an embodiment the second insulator layer 401 may be silicon oxide, silicon nitride, germanium oxide, germanium nitride, combinations of these, or the like, formed using a deposition method such as chemical vapor deposition, atomic layer deposition, physical vapor deposition, combinations of these, or the like. Once the material of the second insulator layer 401 has been deposited, the material may be planarized using, e.g., a chemical mechanical polishing process in order to either planarize a top surface of the second insulator layer 401 (in embodiments in which the second insulator layer 401 is intended to fully cover the first optical components 203) or else planarize the second insulator layer 401 with top surfaces of the first optical components 203. However, any suitable material and method of manufacture may be used.

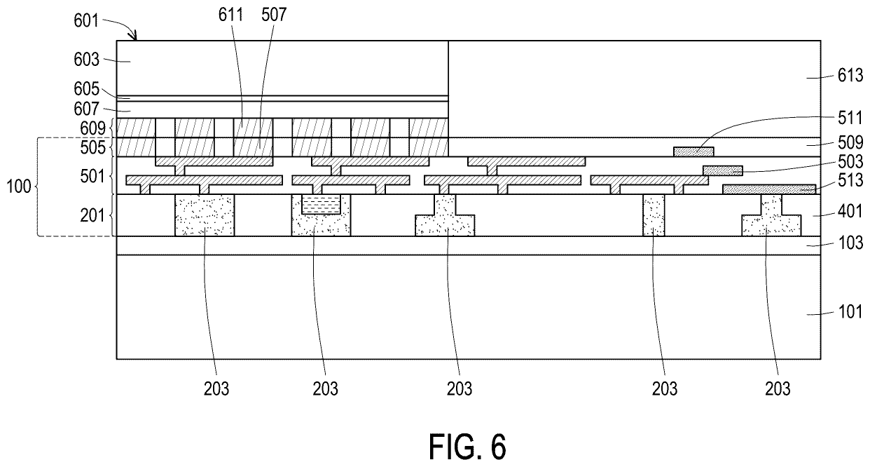

FIG. 5 illustrates that, once the first optical components 203 of the first active layer 201 have been manufactured and the second insulator layer 401 has been formed, first metallization layers 501 are formed in order to electrically connect the first active layer 201 of first optical components 203 to control circuitry, to each other, and to subsequently attached devices (not illustrated in FIG. 5 but illustrated and described further below with respect to FIG. 6). In an embodiment the first metallization layers 501 are formed of alternating layers of dielectric and conductive material and may be formed through any suitable processes (such as deposition, damascene, dual damascene, etc.). In particular embodiments there may be multiple layers of metallization used to interconnect the various first optical components 203, but the precise number of first metallization layers 501 is dependent upon the design of the optical interposer 100.

Additionally, during the manufacture of the first metallization layers 501, one or more second optical components 503 may be formed as part of the first metallization layers 501. In some embodiments the second optical components 503 of the first metallization layers 501 may include such components as couplers (e.g., edge couplers, grating couplers, etc.) for connection to outside signals, optical waveguides (e.g., ridge waveguides, rib waveguides, buried channel waveguides, diffused waveguides, etc.), optical modulators (e.g., Mach-Zehnder silicon-photonic switches, microelectromechanical switches, micro-ring resonators, etc.), amplifiers, multiplexors, demultiplexors, optical-to-electrical converters (e.g., P-N junctions), electrical-to-optical converters, lasers, combinations of these, or the like. However, any suitable optical components may be used for the one or more second optical components 503.

In an embodiment the one or more second optical components 503 may be formed by initially depositing a material for the one or more second optical components 503. In an embodiment the material for the one or more second optical components 503 may be a dielectric material such as silicon nitride, silicon oxide, combinations of these, or the like, or a semiconductor material such as silicon, deposited using a deposition method such as chemical vapor deposition, atomic layer deposition, physical vapor deposition, combinations of these, or the like. However, any suitable material and any suitable method of deposition may be utilized.

Once the material for the one or more second optical components 503 has been deposited or otherwise formed, the material may be patterned into the desired shapes for the one or more second optical components 503. In an embodiment the material of the one or more second optical components 503 may be patterned using, e.g., one or more photolithographic masking and etching processes. However, any suitable method of patterning the material for the one or more second optical components 503 may be utilized.

For some of the one or more second optical components 503, such as waveguides or edge couplers, the patterning process may be all or at least most manufacturing that is used to form these components. Additionally, for those components that utilize further manufacturing processes, such as Mach-Zehnder silicon-photonic switches that utilize resistive heating elements, additional processing may be performed either before or after the patterning of the material for the one or more second optical components 503. For example, implantation processes, additional deposition and patterning processes for different materials, combinations of all of these processes, or the like, and can be utilized to help further the manufacturing of the various desired one or more second optical components 503. All such manufacturing processes and all suitable one or more second optical components 503 may be manufactured, and all such combinations are fully intended to be included within the scope of the embodiments.

FIG. 5 additionally illustrates that the second optical components 503 may include one or more edge couplers 513. In embodiments the one or more edge couplers 513 (only one of which is illustrated in FIG. 5 for clarity) may be formed as described above, such as depositing a material such as silicon nitride and then patterning the silicon nitride into the desired shape, such as a silicon nitride tip. However, any suitable materials and shapes may be utilized.

Once the one or more second optical components 503 of the first metallization layers 501 have been manufactured, a first bonding layer 505 is formed over the first metallization layers 501. In an embodiment, the first bonding layer 505 may be used for a dielectric-to-dielectric and metal-to-metal bond. In accordance with some embodiments, the first bonding layer 505 is formed of a first dielectric material 509 such as silicon oxide, silicon nitride, or the like. The first dielectric material 509 may be deposited using any suitable method, such as CVD, high-density plasma chemical vapor deposition (HDPCVD), PVD, atomic layer deposition (ALD), or the like. However, any suitable materials and deposition processes may be utilized.

Once the first dielectric material 509 has been formed, first openings in the first dielectric material 509 are formed to expose conductive portions of the underlying layers in preparation to form first bond pads 507 within the first bonding layer 505. Once the first openings have been formed within the first dielectric material 509, the first openings may be filled with a seed layer and a plate metal to form the first bond pads 507 within the first dielectric material 509. The seed layer may be blanket deposited over top surfaces of the first dielectric material 509 and the exposed conductive portions of the underlying layers and sidewalls of the openings and the second openings. The seed layer may comprise a copper layer. The seed layer may be deposited using processes such as sputtering, evaporation, or plasma-enhanced chemical vapor deposition (PECVD), or the like, depending upon the desired materials. The plate metal may be deposited over the seed layer through a plating process such as electrical or electro-less plating. The plate metal may comprise copper, a copper alloy, or the like. The plate metal may be a fill material. A barrier layer (not separately illustrated) may be blanket deposited over top surfaces of the first dielectric material 509 and sidewalls of the openings and the second openings before the seed layer. The barrier layer may comprise titanium, titanium nitride, tantalum, tantalum nitride, or the like.

Following the filling of the first openings, a planarization process, such as a CMP, is performed to remove excess portions of the seed layer and the plate metal, forming the first bond pads 507 within the first bonding layer 505. In some embodiments a bond pad via (not separately illustrated) may also be utilized to connect the first bond pads 507 with underlying conductive portions and, through the underlying conductive portions, connect the first bond pads 507 with the first metallization layers 501.

Additionally, the first bonding layer 505 may also include one or more third optical components 511 incorporated within the first bonding layer 505. In such an embodiment, prior to the deposition of the first dielectric material 509, the one or more third optical components 511 may be manufactured using similar methods and similar materials as the one or more second optical components 503 (described above), such as by being waveguides and other structures formed at least in part through a deposition and patterning process. However, any suitable structures, materials and any suitable methods of manufacture may be utilized.

FIG. 6 illustrates a bonding of a first semiconductor device 601 to the first bonding layer 505 of the optical interposer 100. In some embodiments, the first semiconductor device 601 is an electronic integrated circuit (EIC—e.g., a device without optical devices) and may have a semiconductor substrate 603, a layer of active devices 605, an overlying interconnect structure 607, a second bonding layer 609, and associated third bond pads 611. In an embodiment the semiconductor substrate 603 may be similar to the first substrate 101 (e.g., a semiconductor material such as silicon or silicon germanium), the active devices 605 may be transistors, capacitors, resistors, and the like formed over the semiconductor substrate 603, the interconnect structure 607 may be similar to the first metallization layers 501 (without optical components), the second bonding layer 609 may be similar to the first bonding layer 505, and the third bond pads 611 may be similar to the first bond pads 507. However, any suitable devices may be utilized.

In an embodiment the first semiconductor device 601 may be configured to work with the optical interposer 100 for a desired functionality. In some embodiments the first semiconductor device 601 may be a high bandwidth memory (HBM) module, an xPU, a logic die, a 3DIC die, a CPU, a GPU, a SoC die, a MEMS die, combinations of these, or the like. Any suitable device with any suitable functionality, may be used, and all such devices are fully intended to be included within the scope of the embodiments.

In an embodiment the first semiconductor device 601 and the first bonding layer 505 may be bonded using a dielectric-to-dielectric and metal-to-metal bonding process. In a particular embodiment which utilizes a dielectric-to-dielectric and metal-to-metal bonding process, the process may be initiated by activating the surfaces of the second bonding layer 609 and the surfaces of the first bonding layer 505. Activating the top surfaces of the first bonding layer 505 and the second bonding layer 609 may comprise a dry treatment, a wet treatment, a plasma treatment, exposure to an inert gas plasma, exposure to H₂, exposure to N₂, exposure to O₂, combinations thereof, or the like, as examples. In embodiments where a wet treatment is used, an RCA cleaning may be used, for example. In another embodiment, the activation process may comprise other types of treatments. The activation process assists in the bonding of the first bonding layer 505 and the second bonding layer 609.

After the activation process the optical interposer 100 and the first semiconductor device 601 may be cleaned using, e.g., a chemical rinse, and then the first semiconductor device 601 is aligned and placed into physical contact with the optical interposer 100. The optical interposer 100 and the first semiconductor device 601 are then subjected to thermal treatment and contact pressure to bond the optical interposer 100 and the laser die 600. For example, the optical interposer 100 and the first semiconductor device 601 may be subjected to a pressure of about 200 kPa or less, and a temperature between about 25° C. and about 250° C. to fuse the optical interposer 100 and the first semiconductor device 601. The optical interposer 100 and the first semiconductor device 601 may then be subjected to a temperature at or above the eutectic point for material of the first bond pads 507 and the third bond pads 611, e.g., between about 150° C. and about 650° C., to fuse the metal. In this manner, the optical interposer 100 and the first semiconductor device 601 forms a dielectric-to-dielectric and metal-to-metal bonded device. In some embodiments, the bonded dies are subsequently baked, annealed, pressed, or otherwise treated to strengthen or finalize the bond.

Additionally, while specific processes have been described to initiate and strengthen the bonds, these descriptions are intended to be illustrative and are not intended to be limiting upon the embodiments. Rather, any suitable combination of baking, annealing, pressing, or combination of processes may be utilized. All such processes are fully intended to be included within the scope of the embodiments.

FIG. 6 additionally illustrates that, once the first semiconductor device 601 has been bonded, a first gap-fill material 613 is deposited in order to fill the space around the first semiconductor device 601 and provide additional support. In an embodiment the first gap-fill material 613 may be a material such as silicon oxide, silicon nitride, silicon oxynitride, combinations of these, or the like, deposited to fill and overfill the spaces around the first semiconductor device 601. However, any suitable material and method of deposition may be utilized.

Once the first gap-fill material 613 has been deposited, the first gap-fill material 613 may be planarized in order to expose the first semiconductor device 601. In an embodiment the planarization process may be a chemical mechanical planarization process, a grinding process, or the like. However, any suitable planarization process may be utilized.

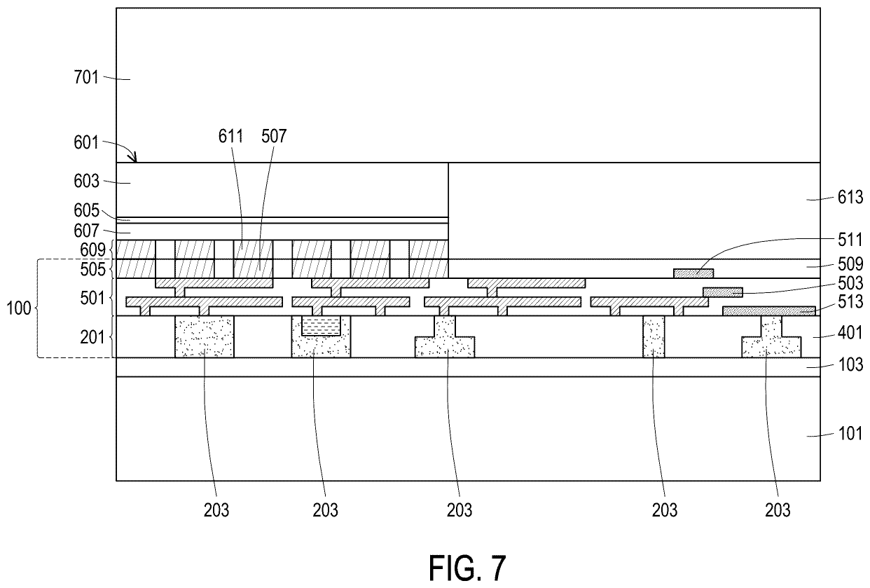

FIG. 7 illustrates an attachment of a first support substrate 701 to the first semiconductor device 601 and the first gap-fill material 613. In an embodiment the first support substrate 701 may be a support material that is transparent to the wavelength of light that is desired to be used, such as silicon, and may be attached using, e.g., an adhesive (not separately illustrated in FIG. 7). However, in other embodiments the first support substrate 701 may be bonded to the first semiconductor device 601 and the first gap-fill material 613 using, e.g., a bonding process. Any suitable method of attaching the first support substrate 701 may be used.

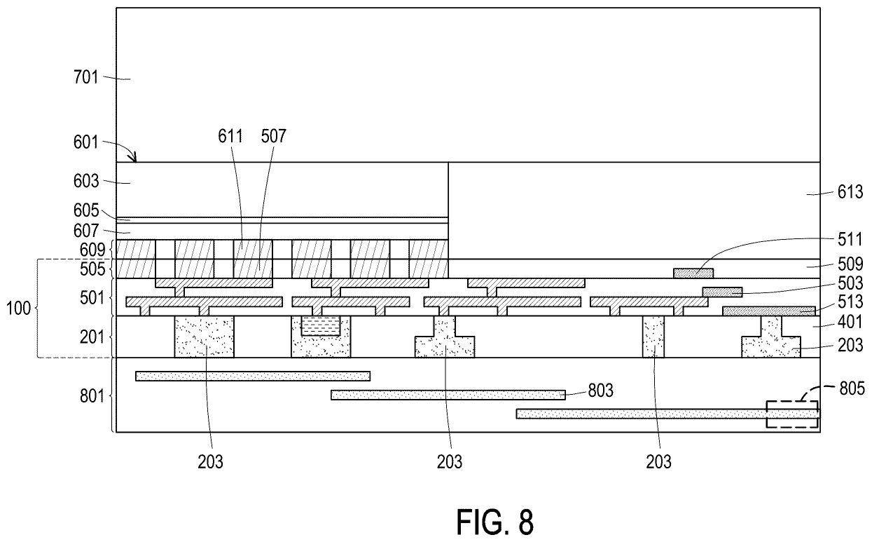

FIG. 8 illustrates a removal of the first substrate 101 and, optionally, the first insulator layer 103, thereby exposing the first active layer 201 of first optical components 203. In an embodiment the first substrate 101 and the first insulator layer 103 may be removed using a planarization process, such as a chemical mechanical polishing process, a grinding process, one or more etching processes, combinations of these, or the like. However, any suitable method may be used in order to remove the first substrate 101 and/or the first insulator layer 103.

Once the first substrate 101 and the first insulator layer 103 have been removed, a second active layer 801 of fourth optical components 803 may be formed on a back side of the first active layer 201. In an embodiment the second active layer 801 of fourth optical components 803 may be formed using similar materials and similar processes as the second optical components 503 of the first metallization layers 501 (described above with respect to FIG. 5). For example, the second active layer 801 of fourth optical components 803 may be formed of alternating layers of a cladding material such as silicon oxide and core material such as silicon nitride formed using deposition and patterning processes in order to form optical components such as waveguides and the like.

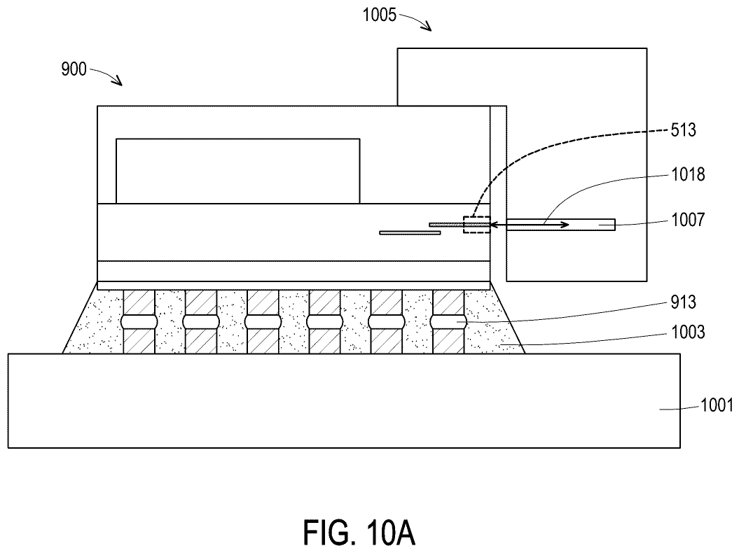

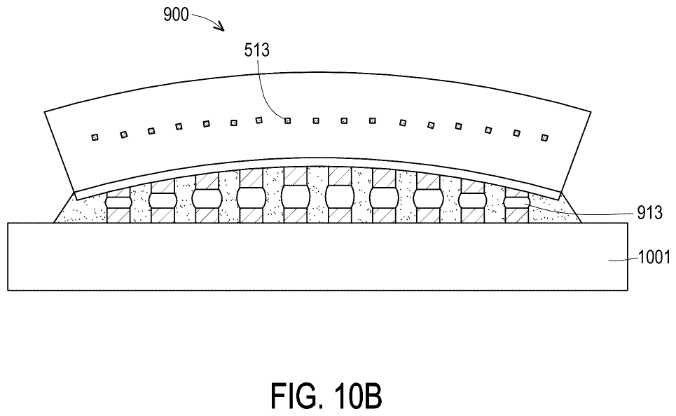

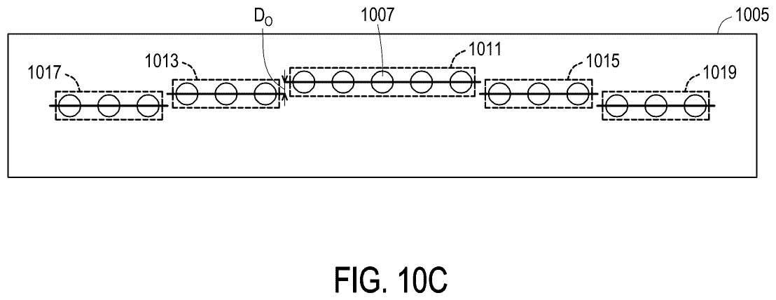

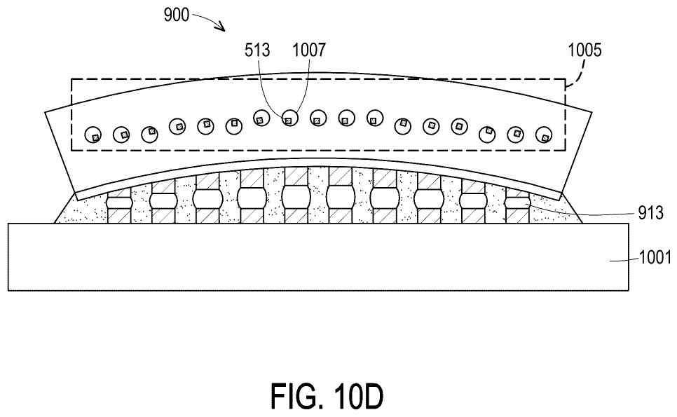

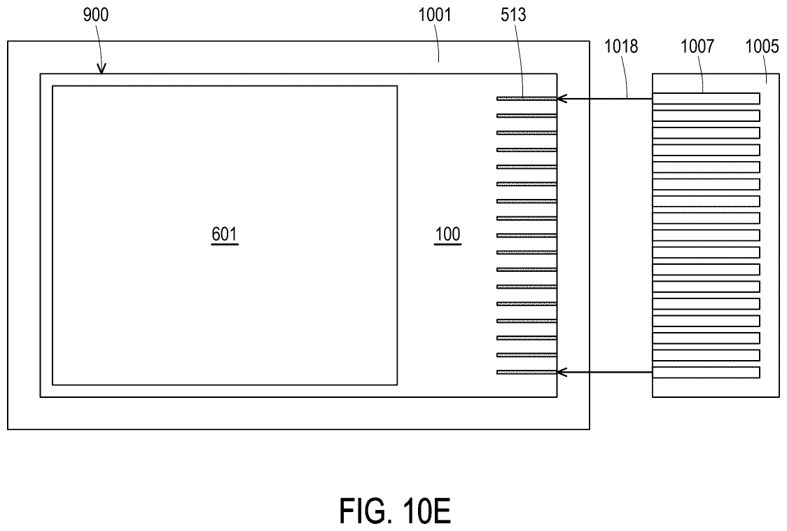

Additionally, in an embodiment the fourth optical components 803 of the second active layer 801 may comprise optical couplers in order to receive and transmit optical signals 1018 (not seen in FIG. 8 but illustrated and discussed further below in FIG. 10A) into and out of the second active layer 801. For example, the fourth optical components 803 may comprise one or more edge couplers (represented by the dashed box labeled 805 in FIG. 8). The one or more edge couplers 805 may comprise one or more edge couplers arranged in a single straight line (not visible in the cross-section seen in FIG. 8) or be located in multiple levels. The individual edge couplers provide multiple optical paths, such as between about 20 and 80 optical paths, such as 40 optical paths. However, any suitable number and arrangement of couplers may be utilized.

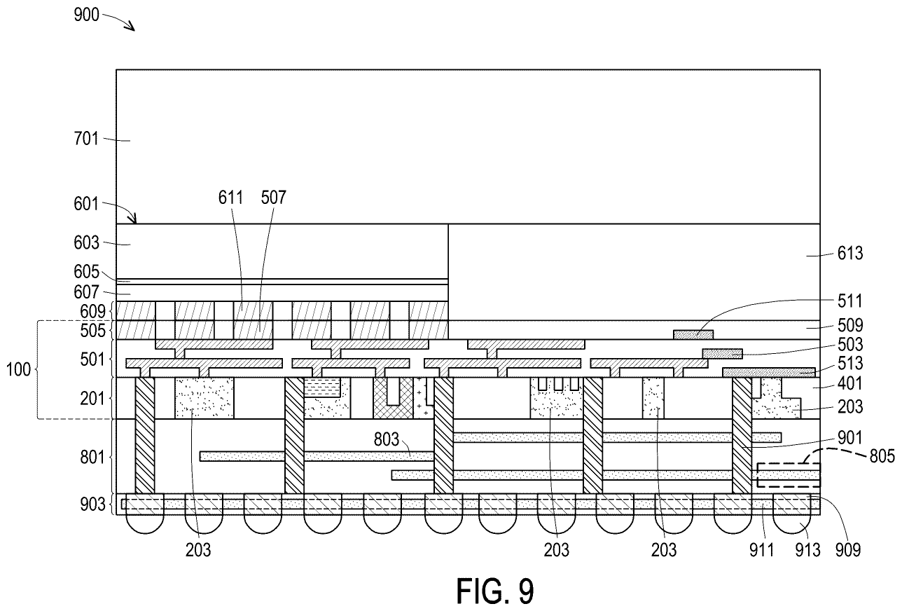

FIG. 9 illustrates formation of first through device vias (TDVs) 901 and formation of a third bonding layer 903 to form a first optical package 900 which, in some embodiments is an optical device or an optical engine. In an embodiment the first through device vias 901 extend through the second active layer 801 and the first active layer 201 so as to provide a quick passage of power, data, and ground through the optical interposer 100. In an embodiment the first through device vias 901 may be formed by initially forming through device via openings into the optical interposer 100. The through device via openings may be formed by applying and developing a suitable photoresist (not shown), and removing portions of the second active layer 801 and the optical interposer 100 that are exposed.

Once the through device via openings have been formed within the optical interposer 100, the through device via openings may be lined with a liner. The liner may be, e.g., an oxide formed from tetraethylorthosilicate (TEOS) or silicon nitride, although any suitable dielectric material may alternatively be used. The liner may be formed using a plasma enhanced chemical vapor deposition (PECVD) process, although other suitable processes, such as physical vapor deposition or a thermal process, may also be used.

Once the liner has been formed along the sidewalls and bottom of the through device via openings, a barrier layer (also not independently illustrated) may be formed and the remainder of the through device via openings may be filled with first conductive material. The first conductive material may comprise copper, although other suitable materials such as aluminum, alloys, doped polysilicon, combinations thereof, and the like, may be utilized. The first conductive material may be formed by electroplating copper onto a seed layer (not shown), filling and overfilling the through device via openings. Once the through device via openings have been filled, excess liner, barrier layer, seed layer, and first conductive material outside of the through device via openings may be removed through a planarization process such as chemical mechanical polishing (CMP), although any suitable removal process may be used.

Optionally, in some embodiments once the first through device vias 901 have been formed, second metallization layers (not separately illustrated in FIG. 9) may be formed in electrical connection with the first through device vias 901. In an embodiment the second metallization layers may be formed as described above with respect to the first metallization layers 501, such as being alternating layers of dielectric and conductive materials using damascene processes, dual damascene process, or the like. In other embodiments, the second metallization layers may be formed using a plating process to form and shape conductive material, and then cover the conductive material with a dielectric material. However, any suitable structures and methods of manufacture may be utilized.

The third bonding layer 903 is formed in order to provide electrical connections between the optical interposer 100 and subsequently attached devices. In an embodiment the third bonding layer 903 may be similar to the first bonding layer 505, such as having third bond pads 909 (similar to the first bond pads 507) and even fifth optical components 911 (similar to the third optical components 511). However, any suitable devices may be utilized.

FIG. 9 additionally illustrates a placement of first external connectors 913 which may be formed to provide conductive regions for contact between the third bond pads 909 to other external devices. The first external connectors 913 may be conductive bumps (e.g., C4 bumps, ball grid arrays, microbumps, etc.) or conductive pillars utilizing materials such as solder and copper. In an embodiment in which the first external connectors 913 are contact bumps, the first external connectors 913 may comprise a material such as tin, or other suitable materials, such as silver, lead-free tin, or copper. In an embodiment in which the first external connectors 913 are tin solder bumps, the first external connectors 913 may be formed by initially forming a layer of tin through such commonly used methods such as evaporation, electroplating, printing, solder transfer, ball placement, etc. Once a layer of tin has been formed on the structure, a reflow may be performed in order to shape the material into the desired bump shape.

Of course, while the use of first external connectors 913 is one embodiment which may be used in order to provide connections for the first optical package 900, this is intended to be illustrative and is not intended to limit the embodiments. Rather, any suitable method of physically, electrically, and in some cases optically connecting the first optical package 900, such as dielectric-to-dielectric and metal-to-metal bonding, may also be utilized. Any suitable method of bonding the first optical package 900 may be used.

FIG. 10A illustrates that, once the first optical package 900 (illustrated in a very simplified form in FIG. 10A) is ready, the first optical package 900 may be attached to an interposer substrate 1001 that is used to couple the first optical package 900 with other devices. In an embodiment the interposer substrate 1001 comprises a semiconductor substrate, third metallization layers, second through device vias (TDVs), and second external connectors (all of which are not illustrated for clarity). The semiconductor substrate may comprise bulk silicon, doped or undoped, or an active layer of a silicon-on-insulator (SOI) substrate. Generally, an SOI substrate comprises a layer of a semiconductor material such as silicon, germanium, silicon germanium, SOI, silicon germanium on insulator (SGOI), or combinations thereof. Other substrates that may be used include multi-layered substrates, gradient substrates, or hybrid orientation substrates.

Optionally, first active devices (not separately illustrated) may be added to the semiconductor substrate. The first active devices comprise a wide variety of active devices and passive devices such as capacitors, resistors, inductors and the like that may be used to generate the desired structural and functional requirements of the design for the semiconductor substrate. The first active devices may be formed using any suitable methods either within or else on the semiconductor substrate.

The third metallization layers are formed over the semiconductor substrate of the interposer substrate 1001 and the first active devices and are designed to connect the various devices to form functional circuitry. In an embodiment the third metallization layers of the interposer substrate 1001 are formed of alternating layers of dielectric (e.g., low-k dielectric materials, extremely low-k dielectric material, ultra low-k dielectric materials, combinations of these, or the like) and conductive material and may be formed through any suitable process (such as deposition, damascene, dual damascene, etc.). However, any suitable materials and processes may be utilized.

Additionally, at any desired point in the manufacturing process, the second TDVs may be formed within the semiconductor substrate and, if desired, one or more layers of the third metallization layers, in order to provide electrical connectivity from a front side of the semiconductor substrate to a back side of the semiconductor substrate. In an embodiment the second TDVs may be formed by initially forming through device via (TDV) openings into the semiconductor substrate and, if desired, any of the overlying third metallization layers (e.g., after the desired third metallization layer has been formed but prior to formation of the next overlying third metallization layer). The TDV openings may be formed by applying and developing a suitable photoresist, and removing portions of the underlying materials that are exposed to a desired depth. The TDV openings may be formed so as to extend into the semiconductor substrate to a depth greater than the eventual desired height of the semiconductor substrate.

Once the TDV openings have been formed within the semiconductor substrate and/or any third metallization layers, the TDV openings may be lined with a liner. The liner may be, e.g., an oxide formed from tetraethylorthosilicate (TEOS) or silicon nitride, although any suitable dielectric material may be used. The liner may be formed using a plasma enhanced chemical vapor deposition (PECVD) process, although other suitable processes, such as physical vapor deposition or a thermal process, may be used.

Once the liner has been formed along the sidewalls and bottom of the TDV openings, a barrier layer may be formed and the remainder of the TDV openings may be filled with first conductive material. The first conductive material may comprise copper, although other suitable materials such as aluminum, alloys, doped polysilicon, combinations thereof, and the like, may be utilized. The first conductive material may be formed by electroplating copper onto a seed layer, filling and overfilling the TDV openings. Once the TDV openings have been filled, excess liner, barrier layer, seed layer, and first conductive material outside of the TDV openings may be removed through a planarization process such as chemical mechanical polishing (CMP), although any suitable removal process may be used.

Once the TDV openings have been filled, the semiconductor substrate may be thinned until the second TDVs have been exposed. In an embodiment the semiconductor substrate may be thinned using, e.g., a chemical mechanical polishing process, a grinding process, or the like. Further, once exposed, the second TDVs may be recessed using, e.g., one or more etching processes, such as a wet etch process in order to recess the semiconductor substrate so that the second TDVs extend out of the semiconductor substrate.

In an embodiment the second external connectors may be placed and may be, e.g., a ball grid array (BGA) which comprises a eutectic material such as solder, although any suitable materials may be used. Optionally, an underbump metallization or additional metallization layers may be utilized between the third metallization layers and the second external connectors. In an embodiment in which the second external connectors are solder bumps, the second external connectors may be formed using a ball drop method, such as a direct ball drop process. In another embodiment, the solder bumps may be formed by initially forming a layer of tin through any suitable method such as evaporation, electroplating, printing, solder transfer, and then performing a reflow in order to shape the material into the desired bump shape. Once the second external connectors have been formed, a test may be performed to ensure that the structure is suitable for further processing.

Once the interposer substrate 1001 has been formed, the first optical package 900 may be attached to the interposer substrate 1001. In an embodiment the first optical package 900 may be attached to the interposer substrate 1001 by aligning the first external connectors 913 with conductive portions of the interposer substrate 1001. Once aligned and in physical contact, the first external connectors 913 are reflowed by raising the temperature of the first external connectors 913 past a eutectic point of the first external connectors 913, thereby shifting the material of the first external connectors 913 to a liquid phase. Once reflowed, the temperature is reduced in order to shift the material of the first external connectors 913 back to a solid phase, thereby bonding the first optical package 900 to the interposer substrate 1001.

Optionally, a first underfill material 1003 may be placed. The first underfill material 1003 material may reduce stress and protect the joints resulting from the reflowing of the first external connectors 913. The first underfill material 1003 may be formed by a capillary flow process after the first optical package 900 has been attached.

FIG. 10B illustrates a side view of the first optical package 900 after bonding to the interposer substrate 1001, and in particular shows the plurality of edge couplers 513 formed within the second optical components 503 (although it could alternatively be the edge couplers 805 within the fourth optical components 803 or any other edge coupler). FIG. 10B additionally illustrates that, during the bonding process that is used to bond the first optical package 900 to the interposer substrate 1001, the stresses involved may cause the first optical package 900 to warp such that the edge couplers 513 (which had been manufactured to be in a straight line) are now misaligned with each adjacent ones of the edge couplers 513, such that the previously formed straight line now has a curvature in it. In particular embodiments the overall die warp may be between 16 μm and about 27 μm, while a die edge warp may be between about 9 μm and about 10 μm.

Returning now to FIG. 10A, there is also illustrated that, once the first optical package 900 has been bonded to the interposer substrate 1001, a fiber array unit (FAU) 1005 is attached to the first optical package 900 in order to provide an input and output for optical signals (represented in FIG. 10A by the arrow labeled 1018) to the first optical package 900. In an embodiment the fiber array unit 1005 receives optical fibers 1007, arranges the optical fibers 1007 with a fiber sheath, and directs the optical signals 1018 from the optical fibers 1007 towards the edge couplers 513. The fiber array unit 1005 additionally will receive the optical signals 1018 from the edge couplers 513 at the optical fibers 1007, which will carry the optical signals 1018 away from the device.

FIG. 10C illustrates an orientation of the individual optical fibers 1007 within the fiber array unit 1005 that works to compensate for the warpage caused by the bonding of the first optical package 900 to the interposer substrate 1001. In particular, the optical fibers 1007 are orientated so that the optical fibers 1007 are not in a direct line, but are, instead, arranged in such a fashion as to accommodate the warpage. In a particular embodiment, the optical fibers 1007 are misaligned so that the individual optical fibers 1007 are more closely aligned with their respective edge couplers 513 after the bonding has occurred and the warpage has occurred.

In the embodiment illustrated in FIG. 10C, the individual optical fibers 1007 may be arranged in multiple groups, wherein each of the optical fibers 1007 within a single group are aligned with each other at a same Z-height. In order to determine the number of groups, die edge warp behaviors are obtained for new products, and the optical fibers are divided into N groups which have a Z-height different within 1 μm of each other. In particular embodiments, a width of a die edge of the first optical package divided by the number of groups is between about 0.33 mm and about 1.4 mm. However, any suitable method of grouping the optical fibers 1007 may be utilized.

In a particular embodiment the individual optical fibers 1007 may be arranged into five groups. These groups may include a first group 1011, a second group 1013, a third group 1015, a fourth group 1017, and a fifth group 1019, wherein the first group 1011 is located in a center region, the second group 1013 and the third group 1015 are located adjacent to the first group 1011, and the fourth group 1017 and the fifth group 1019 are located on edge regions. Additionally, centerlines (represented in FIG. 10C by the lines labeled 1021) of the individual groups are offset in the Z-height (e.g., vertical) direction from centerlines 1021 of adjacent groups.

In a particular embodiment each of the multiple groups may comprise one or more of the optical fibers 1007. For example, the individual groups may comprise between 2 and 10 optical fibers 1007. In the particular embodiment illustrated in FIG. 10C, the first group 1011 comprises five optical fibers 1007, the second group 1013 and the third group 1015 each comprise three optical fibers 1007, and the fourth group 1017 and the fifth group 1019 also comprise three optical fibers 1007. However, any suitable number of optical fibers 1007 in each group may be utilized.

Additionally, the multiple groups may be arranged to address the warpage of the edge couplers 513 within the first optical package 900. As such, the multiple groups may be arranged so that individual groups of the multiple groups are offset from immediately adjacent groups. However, the multiple groups still overlap each other so that the multiple groups are offset by a distance at least less than a diameter of the optical fibers 1007. As such, the multiple groups have a stair-like gradual sloping arrangement wherein individual groups have a vertical offset distance Dₒ (e.g., an offset from a centerline 1021 of one group to a centerline 1021 of an immediately adjacent group) of between about 0.5 μm and about 2 μm. However, any suitable distance and any suitable arrangement may be utilized.

Additionally, if desired, multiple ones of the groups may be aligned with other groups that are not immediately adjacent to them. For example, in some embodiments, the second group 1013 and the third group 1015 (on opposite sides of the first group 1011) may be aligned with each other and be located at the same height within the fiber array unit 1005. Similarly, the fourth group 1017 and the fifth group 1019 may be aligned with each other and be located at the same height within the fiber array unit 1005.

However, while a particular orientation of the groupings is illustrated and discussed above with respect to FIG. 10C, this is intended to illustrative and is not intended to limit the embodiments. Rather, any suitable orientation, with any suitable number of groups and/or optical fibers per group, may be used. All such configurations are fully intended to be included within the scope of the embodiments.

In an embodiment the fiber array unit 1005 can be attached by initially positioning the optical fibers 1007 within the fiber array unit 1005 to be aligned with the edge couplers 513. Once the optical fibers 1007 have been aligned, the fiber array unit 1005 may be attached using, e.g., an optional optical glue (not separately illustrated in FIG. 10A). In some embodiments, the optical glue comprises a polymer material such as epoxy-acrylate oligomers, and may have a refractive index between about 1 and about 3. However, any suitable material or other method of attachment may be utilized.

FIG. 10D illustrates the alignment of the optical fibers 1007 and the edge couplers 513 after the attachment of the fiber array unit 1005 to the first optical package 900. As can be seen, while the individual edge couplers 513 are misaligned due to the warpage, by arranging the optical fibers 1007 as described above with respect to FIG. 10C, the optical fibers 1007 can be better aligned with their respective edge couplers 513. Additionally, as can be seen, the center region is flatter than the edge regions, and the z-height difference of the center region may be larger than or the same as the Z-height difference of the edge region.

FIG. 10E illustrates a top-down, simplified view of the first optical package 900, the interposer substrate 1001, and the fiber array unit 1005 after the fiber array unit 1005 has been attached. As can be seen clearly in this top-down view, each of the optical fibers 1007 within the fiber array unit 1005 is aligned with respective ones of the edge couplers 513. As such, optical signals 1018 from the optical fibers 1007 can be directed towards the edge couplers 513, and optical signals 1018 from the edge couplers 513 can be directed towards the optical fibers 1007.

By arranging the optical fibers 1007 within the fiber array unit 1005 as described above, transmission losses caused by warpage of the first optical package 900 may be mitigated. As such, die warpage design constraints can be released and a larger alignment window can be achieved. All of this can be performed while still using a feasible fabrication process.

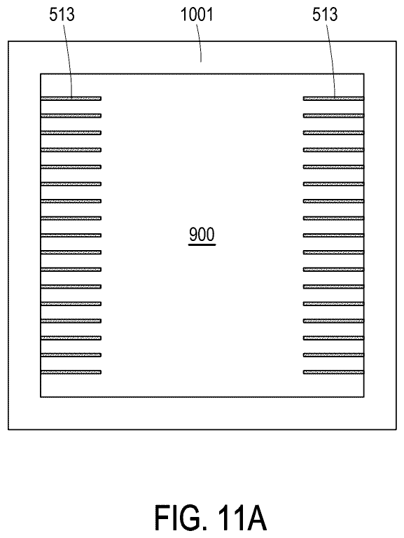

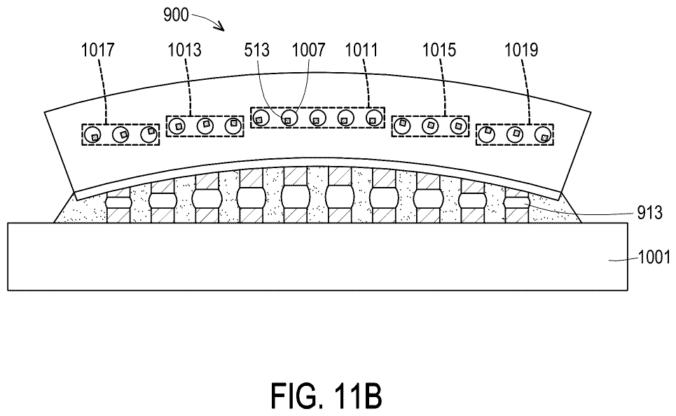

FIG. 11A-11B illustrate another embodiment in which the edge couplers 513 within the first optical package 900 are arranged on multiple sides of the first optical package 900 (wherein the first optical package 900 is illustrated in FIG. 11A in a very simplified form and the fiber array unit 1005 is not illustrated at all for clarity). In this embodiment the first optical package 900 is illustrated as being square, wherein each side of the first optical package 900 has an equal width, thereby causing the first optical package 900 to have similar warping characteristics along each side. Additionally, the edge couplers 513 are arranged on opposite sides of the first optical package 900.

FIG. 11B illustrates a side view of the edge couplers 513 with an arrangement of corresponding optical fibers 1007. Because the sides of the first optical package 900 are the same and have similar warping characteristics, the view illustrated in FIG. 11B corresponds to either side of the first optical package 900.

Also illustrated in FIG. 11B are the optical fibers 1007 aligned with the edge couplers 513. In an embodiment the optical fibers 1007 may be arranged as described above with respect to FIG. 10c, such as by being arranged in a numbers of groupings (e.g., the first group 1011, the second group 1-13, the third group 1015, the fourth group 1017, and the fifth group 1019) offset from each other. However, any suitable arrangements or combination of arrangements may be utilized.

Additionally, while FIG. 11B illustrates a single side of the first optical package 900 illustrated in FIG. 11A, the second side of the first optical package 900 may have a similar structure. In particular, if the arrangement of the edge couplers 513 is manufactured in a similar fashion on both sides, and if the warpage of the first optical package 900 is similar on both sides of the first optical package 900, then the second side has a similar arrangement as the first side, and FIG. 11B illustrates either of the first side or the second side of the first optical package 900.

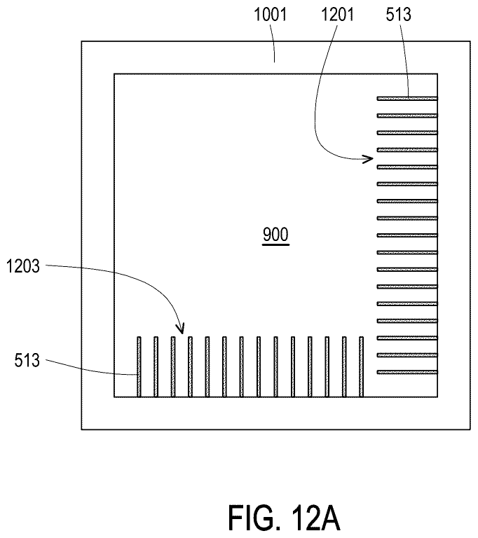

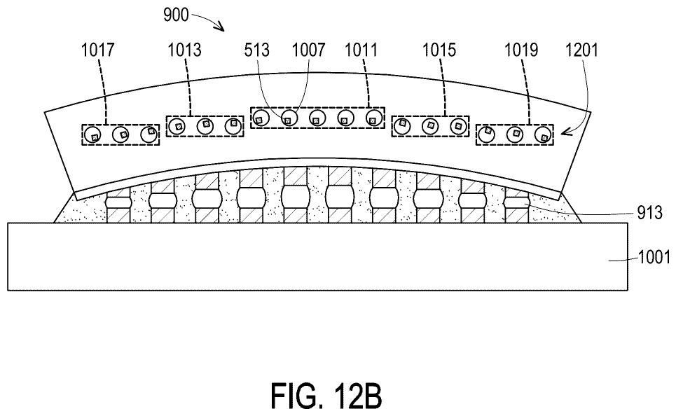

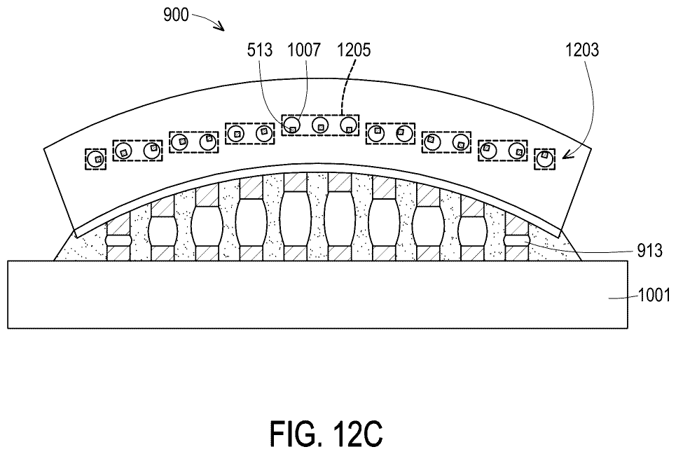

FIGS. 12A-12C illustrate yet another embodiment wherein the edge couplers 513 are arranged on multiple sides of the first optical package 900. In this embodiment, however, the edge couplers 513 are on adjacent sides of the first optical package 900 (instead of on opposing sides as illustrated in FIG. 11A above). As such, there may be a first grouping 1201 of the edge couplers 513 along a first side of the first optical package 900 and a second grouping 1203 of the edge couplers 513 along a second side of the first optical package 900 adjacent to the first side of the first optical package 900.

However, given the presence of the first grouping 1201 and the second grouping 1203 along adjacent sides of the first optical package 900, the different groupings may have different warping behaviors. As such, the optical fibers 1007 aligned with the first grouping 1201 of the edge couplers 513 may be arranged in a different arrangement than the optical fibers 1007 aligned with the second grouping 1203 of the edge couplers 513. However, in other embodiments the optical fibers 1007 aligned with the first grouping 1201 of the edge couplers 513 may be arranged in a similar arrangement as the optical fibers 1007 aligned with the second grouping 1203 of the edge couplers 513.

Looking at FIG. 12B, in an embodiment in which the optical fibers 1007 aligned with the first grouping 1201 of the edge couplers 513 are arranged in a different arrangement than the optical fibers 1007 aligned with the second grouping 1203 of the edge couplers 513, the optical fibers 1007 aligned with the first grouping 1201 of the edge couplers 513 may be arranged as described above with respect to FIG. 10C, such as by being arranged in a numbers of arrangements (e.g., the first group 1011, the second group 1013, the third group 1015, the fourth group 1017, and the fifth group 1019) offset from each other. However, any suitable arrangement or combination of arrangements may be utilized.

FIG. 12C illustrates that a different arrangement of the optical fibers 1007 may be used for the second grouping 1203 of the edge couplers 513 when the second grouping 1203 is warped in a different manner than the first grouping 1201. As illustrated in FIG. 12C, in this embodiment the warping differences between the first grouping 1201 and the second grouping 1203 would cause the edge couplers 513 in the second grouping 1203 to be located in different positions than the edge couplers 513 in the first grouping 1201 (seen in FIG. 12B). For example, in one particular embodiment, the optical fibers 1007 may be arranged in nine groupings 1205, with one grouping in the middle comprising three optical fibers, adjacent groupings comprising two optical fibers 1007 apiece, and the outer groupings comprising a single optical fiber 1007 each. However, any suitable arrangements may be utilized.

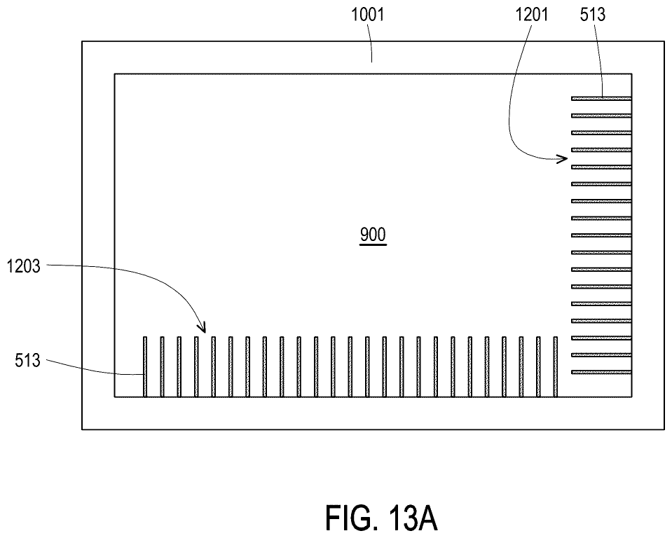

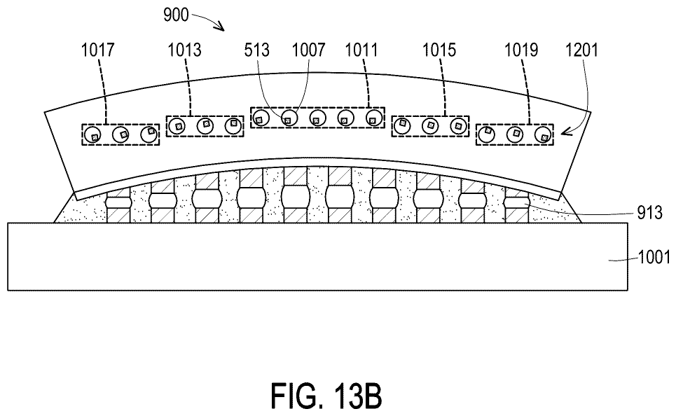

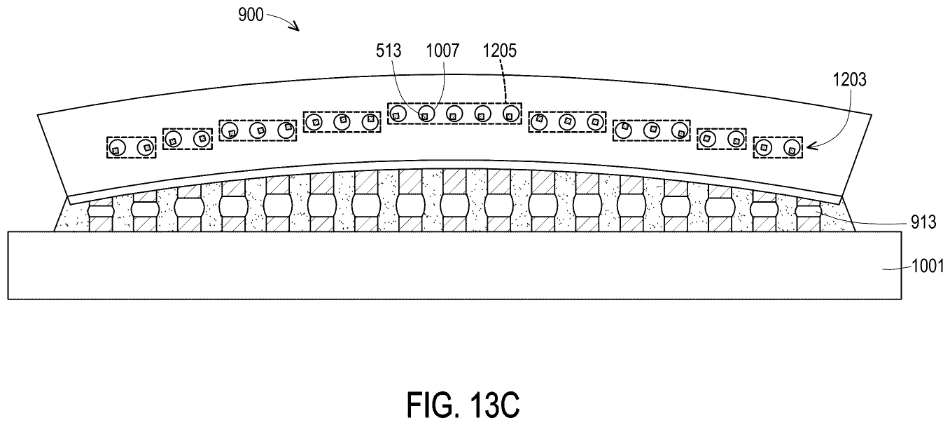

FIGS. 13A-13C illustrate yet another embodiment wherein the edge couplers 513 are arranged on multiple sides of the first optical package 900, but in which one side of the first optical package 900 is larger than the second side of the first optical package 900. In this embodiment the edge couplers 513 are on adjacent sides of the first optical package 900. As such, there may be the first grouping 1201 of the edge couplers 513 along the first side of the first optical package 900 (e.g., the shorter side) and the second grouping 1203 of the edge couplers 513 along the second side of the first optical package 900 (e.g., the longer side) adjacent to the first side of the first optical package 900.

However, given not only the presence of the first grouping 1201 and the second grouping 1203 along adjacent sides of the first optical package 900 but also the different lengths of the sides, the first grouping 1201 and the second grouping 1203 will have different warping behaviors. As such, the optical fibers 1007 aligned with the first grouping 1201 of the edge couplers 513 may be arranged in a different arrangement than the optical fibers 1007 aligned with the second grouping 1203 of the edge couplers 513. However, in other embodiments the optical fibers 1007 aligned with the first grouping 1201 of the edge couplers 513 may be arranged in a similar arrangement as the optical fibers 1007 aligned with the second grouping 1203 of the edge couplers 513.

Looking at FIG. 13B, in an embodiment in which the optical fibers 1007 aligned with the first grouping 1201 of the edge couplers 513 are arranged in a different arrangement than the optical fibers 1007 aligned with the second grouping 1203 of the edge couplers 513, the optical fibers 1007 aligned with the first grouping 1201 of the edge couplers 513 may be arranged as described above with respect to FIG. 10C, such as by being arranged in a numbers of arrangements offset from each other.

FIG. 13C illustrates that a different arrangement of the optical fibers 1007 may be used for the second grouping 1203 of the edge couplers 513. As illustrated in FIG. 12C, in this embodiment the warping differences between the first side of the first optical package 900 and the second side of the first optical package 900 would cause the edge couplers 513 to be located in different positions than the edge couplers 513 on the first side. For example, in one particular embodiment, the optical fibers 1007 may be arranged with three groupings of five optical fibers 1007 each, two groupings of three optical fibers 1007, and four groupings of two optical fibers 1007 each. However, any suitable arrangements may be utilized.

By using the embodiments described above, transmission losses caused by misalignment between warped edge couplers and optical fibers can be mitigated. Such mitigation allows the design constraints limited by warpage can be released and an overall larger alignment window can be achieved. All of this can be performed while still using a feasible fabrication process.

In an embodiment, a method of manufacturing an optical device, the method including: receiving a fiber array unit, wherein after the receiving optical fibers extend through the fiber array unit, wherein the optical fibers are arranged in a plurality of groupings, each grouping of the plurality of groupings being offset from adjacent groupings of the plurality of groupings by a first distance, the first distance being less than a diameter of one of the optical fibers; and attaching the fiber array unit to an optical device. In an embodiment the optical device is a first optical package. In an embodiment the optical fibers are aligned with edge couplers within the first optical package, the edge couplers being warped out of a straight line alignment. In an embodiment the method further includes attaching a second fiber array unit to a second side of the first optical package different from a first side adjacent the fiber array unit. In an embodiment the first side has a different length than the second side. In an embodiment the first distance is between about 0.5 μm and about 2 μm. In an embodiment a first grouping of the plurality of groupings has a first number of optical fibers and wherein a second grouping of the plurality of groupings has a second number of optical fibers different from the first number.

In another embodiment, a method of manufacturing an optical device includes: bonding a first optical package to an interposer substrate, wherein the bonding warps a line of edge couplers within the first optical package; and attaching a fiber array unit to a first side of the first optical package, the fiber array unit including: a first group of optical fibers; and a second group of optical fibers, the second group of optical fibers being offset from the first group of optical fibers by a distance of less than about 2 μm. In an embodiment the distance is greater than about 0.5 μm. In an embodiment the first group of optical fibers has a first number of optical fibers and the second group of optical fibers has a second number of optical fibers different from the first number of optical fibers. In an embodiment the method further includes attaching a second fiber array unit to a second side of the first optical package. In an embodiment the second side is opposite the first side. In an embodiment the second side is adjacent to the first side. In an embodiment the first side has a different length than the second side.

In yet another embodiment, an optical device including: a first optical package bonded to an interposer substrate, wherein couplers within the first optical package are offset from each other; and a fiber array unit on a first side of the first optical package, the fiber array unit including: a first group of optical fibers; and a second group of optical fibers, the second group of optical fibers being offset from the first group of optical fibers by a distance of less than about 2 μm. In an embodiment the distance is greater than about 0.5 μm. In an embodiment the first group of optical fibers has a different number of optical fibers than the second group of optical fibers. In an embodiment the optical device further includes a second fiber array unit attached to a second side of the first optical package. In an embodiment the first side is opposite the second side. In an embodiment the first side is adjacent to the second side.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method of manufacturing an optical device, the method comprising:
receiving a fiber array unit, wherein after the receiving optical fibers extend through the fiber array unit, wherein the optical fibers are arranged in a plurality of groupings, each grouping of the plurality of groupings being offset from adjacent groupings of the plurality of groupings by a first distance, the first distance being less than a diameter of one of the optical fibers; and
attaching the fiber array unit to an optical device.

2. The method of claim 1, wherein the optical device is a first optical package.

3. The method of claim 2, wherein the optical fibers are aligned with edge couplers within the first optical package, the edge couplers being warped out of a straight line alignment.

4. The method of claim 2, further comprising attaching a second fiber array unit to a second side of the first optical package different from a first side adjacent the fiber array unit.

5. The method of claim 4, wherein the first side has a different length than the second side.

6. The method of claim 1, wherein the first distance is between about 0.5 μm and about 2 μm.

7. The method of claim 1, wherein a first grouping of the plurality of groupings has a first number of optical fibers and wherein a second grouping of the plurality of groupings has a second number of optical fibers different from the first number.

8. A method of manufacturing an optical device, the method comprising:
bonding a first optical package to an interposer substrate, wherein the bonding warps a line of edge couplers within the first optical package; and
attaching a fiber array unit to a first side of the first optical package, the fiber array unit comprising:
a first group of optical fibers; and
a second group of optical fibers, the second group of optical fibers being offset from the first group of optical fibers by a distance of less than about 2 μm.

9. The method of claim 8, wherein the distance is greater than about 0.5 μm.

10. The method of claim 8, wherein the first group of optical fibers has a first number of optical fibers and the second group of optical fibers has a second number of optical fibers different from the first number of optical fibers.

11. The method of claim 8, further comprising attaching a second fiber array unit to a second side of the first optical package.

12. The method of claim 11, wherein the second side is opposite the first side.

13. The method of claim 11, wherein the second side is adjacent to the first side.

14. The method of claim 11, wherein the first side has a different length than the second side.

15. An optical device comprising:
a first optical package bonded to an interposer substrate, wherein couplers within the first optical package are offset from each other; and
a fiber array unit on a first side of the first optical package, the fiber array unit comprising:
a first group of optical fibers; and
a second group of optical fibers, the second group of optical fibers being offset from the first group of optical fibers by a distance of less than about 2 μm.

16. The optical device of claim 15, wherein the distance is greater than about 0.5 μm.

17. The optical device of claim 15, wherein the first group of optical fibers has a different number of optical fibers than the second group of optical fibers.

18. The optical device of claim 15, further comprising a second fiber array unit attached to a second side of the first optical package.

19. The optical device of claim 18, wherein the first side is opposite the second side.

20. The optical device of claim 18, wherein the first side is adjacent to the second side.
